(19) United States
(12) Patent Application Publication
(10) Pub. No.: US 2005/0143161 A1
(43) Pub. Date: Jun. 30, 2005

(54) Gaming machine

(75) Inventor: Noritoshi Kukita, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 11/019,551

(22) Filed: Dec. 23, 2004

(30) Foreign Application Priority Data
Dec. 26, 2003 (JP) P2003-435134

(51) Int. Cl. A63F 13/00

(52) U.S. Cl. 463/17; 463/46

(57) ABSTRACT

A gaming machine including a cabinet internally having a cabinet frame, a rocking frame oscillatably supporting the cabinet, an rocking device for oscillating the cabinet, an attachment base fixed to the cabinet frame, at least one substantially entire surface of which is a ground plane, a lottery wheel disposed above the attachment base and having a plurality of lottery holes to which lottery balls enter, a detector attached to the attachment base for detecting that a lottery ball enters to the lottery hole; and a strut extending upward from the position of the lottery wheel and electrically connecting to the cabinet frame and the ground plane.

### CROSS-REFERENCE TO THE RELATED APPLICATION(S)

This application is based upon and claims a priority from prior Japanese Patent Application No. 2003-435134 filed on Dec. 26, 2003, the entire contents of which are incorporated herein by reference. This application is related to co-pending U.S. applications claiming priorities for JP-2003-435133 to file on the even date with this application, U.S. applications claiming priorities for JP-2003-316020, and JP-2003-316021, filed on Sep. 8, 2004, International Application No. PCT/JP/03/11439, PCT/JP/03/11440, and PCT/JP/03/11441, filed on Sep. 8, 2003 in Japan. The co-pending applications are expressly incorporated herein by reference.

### BACKGROUND OF THE INVENTION

1. Field of the Invention

The present invention relates to a gaming machine, and more specifically, it relates to a gaming machine determining a result of a game based on a fact that a lottery ball enters to a lottery hole in the lottery wheel.

2. Description of the Related Art

Hitherto, a bingo game is played by using a bingo card having squares aligned in a matrix form. In this case, different indicias are assigned to the squares, and the square corresponding to the indicia won by a lottery is punched. You can win by punching squares aligned in one vertical, horizontal or diagonal line.

While a bingo card made of paper is generally used in a bingo game, various electronically controlled gaming machines (see JP-A-2001-161888, for example) imitating the game have been developed. Such a gaming machine displays a bingo card on a display device thereof, and, when an indicia won by a lottery exists on the bingo card, the box is activated to display so that the activated box can be distinguished from the other boxes. Generally, a lottery wheel has a plurality of lottery holes having indicia, and, when a lottery ball stops at one of the lottery holes, a square corresponding to the indicia where the lottery ball stops is activated. The gaming machine is often placed in a game arcade since many game players can participate therein.

In order to further increase the amusingness of a game, various attempts are being made in developing this kind of gaming machine, such as moving a part of a gaming machine to dynamically change a condition for a lottery ball to stop at a lottery hole for variety of the game and/or decorating a gaming machine itself based on a theme defined for the game.

By the way, in a game arcade where the gaming machine is placed, many machines such as gaming machines and a money changer are closely provided. A player uses equipment such as a cellular phone and audio and video apparatus. Thus, the gaming machine is required not to prevent normal operations of the other equipment. Especially, an amount of radiant noise, which is electromagnetic waves, generated by the gaming machine must be kept equal to or lower than a predetermined standard such that electromagnetic interference (EMI) can be prevented. Besides, Class A that is applied to the one to use in the industrial area (Section 5 of Electrical Appliance and Material Safety Law) is given as the example of “the predetermined standard”. For a gaming machine to be provided in a game arcade, their own regulations are defined in addition to the legal EMI regulations.

However, a gaming machine to be provided in a game arcade is larger in size and weight than a home gaming machine as well as various apparatus included in the gaming machine. Furthermore, since the various apparatus are driven by high voltage and large current, the amount of radiant noise generated by the gaming machine may easily increase. Especially, when a part or all of the body of the gaming machine is operated, the spatial distribution of the radiant noise varies with time. Thus, the radiant noise must be lower than an acceptable amount even in any state that the gaming machine can be placed, and a sufficient margin must be allowed for a predetermined acceptable limit.

### SUMMARY OF THE INVENTION

An object of the invention is to provide a gaming machine, which can increase amusingness of a game and suppress the generation of radiant noise.

More specifically, the invention provides the following gaming machine.

According to a first aspect of the invention there is provided a gaming machine including: a cabinet frame; a non-conductive cabinet internally having the cabinet frame; a rocking frame oscillatably supporting the cabinet; an rocking device for oscillating the cabinet; an attachment base fixed to the cabinet frame, at least one substantially entire surface of which is a ground plane; a lottery wheel disposed above the attachment base and having a plurality of lottery holes to which lottery balls enter; a discharge device that is provided below the lottery wheel and that discharges the lottery balls entering, one each, the plural lottery holes; a control substrate electrically connected to the ground plane for detecting that a lottery ball enters to the lottery hole.

Further, according to a second aspect of the invention there is provided a gaming machine including: a cabinet frame; a cabinet internally having the cabinet frame; a rocking frame oscillatably supporting the cabinet; an rocking device for oscillating the cabinet; an attachment base fixed to the cabinet frame, at least one substantially entire surface of which is a ground plane; a lottery wheel disposed above the attachment base and having a plurality of lottery holes to which lottery balls enter; a detector attached to the attachment base for detecting that a lottery ball enters to the lottery hole; and a strut extending upward from the position of the lottery wheel and electrically connecting to the cabinet frame and the ground plane.

According to the first and the second aspect of the invention, substantially all of one surface of the attachment base fixed to the cabinet frame within the cabinet is a ground plane, and the cabinet frame and strut are electrically connected thereto. The attachment base to which the detector is attached and the strut extending upward are grounded so that the radiant noise generated by the gaming machine can be suppressed. Furthermore, the strut and the lottery wheel rock in response to the rocking of the cabinet so that the rocking of the cabinet can be visually emphasized. Therefore, the generated radiant noise can be suppressed, and the presence can be enhanced by the rocking of the cabinet, which can increase the amusingness of a game.

### BRIEF DESCRIPTION OF THE DRAWINGS

These and other objects and advantages of the present invention will be more fully apparent from the following detailed description taken in conjunction with the accompanying drawings, in which:

FIG. 1 is a perspective view showing a schematic appearance of a gaming machine of one embodiment of the invention;

FIG. 2 is a longitudinal sectional view showing a schematic appearance of a lottery machine of one embodiment of the invention;

FIG. 3 is a sectional view showing a cabinet frame and attachment base of one embodiment of the invention;

FIG. 4 is a top view of a lottery ball receiving portion of one embodiment of the invention;

FIG. 5 is a top view of a lottery wheel of one embodiment of the invention;

FIG. 6 is a perspective view of a lottery wheel of one embodiment of the invention;

FIG. 7 is a perspective view showing a open/close shutter of one embodiment of the invention;

FIG. 8 is a perspective view showing an operation part of a gaming terminal of one embodiment of the invention;

FIG. 9 is a diagram showing a system configuration in a gaming machine of one embodiment of the invention.

FIG. 10 is a diagram showing an electric configuration in a lottery machine of one embodiment of the invention;

FIG. 11 is a diagram showing an electric configuration in a gaming terminal of one embodiment of the invention;

FIG. 12 is an example of a standby screen of a gaming terminal to be displayed on a display screen of the gaming terminal of one embodiment of the invention; and

FIG. 13 is an example of a screen of a gaming terminal after a game entry to be displayed on a display screen of the gaming terminal of one embodiment of the invention.

### DETAILED DESCRIPTION OF THE PREFERRED EMBODIMENTS

An example of embodiments of the invention will be described with reference to drawings.

While a gaming machine 310 of this embodiment is a gaming machine to be played by using a game medium such as a card storing information on a game value given to or to be given to a game player as well as a coin, medal, lottery ball or token, a medal is used in the description below.

Configuration of Gaming Machine

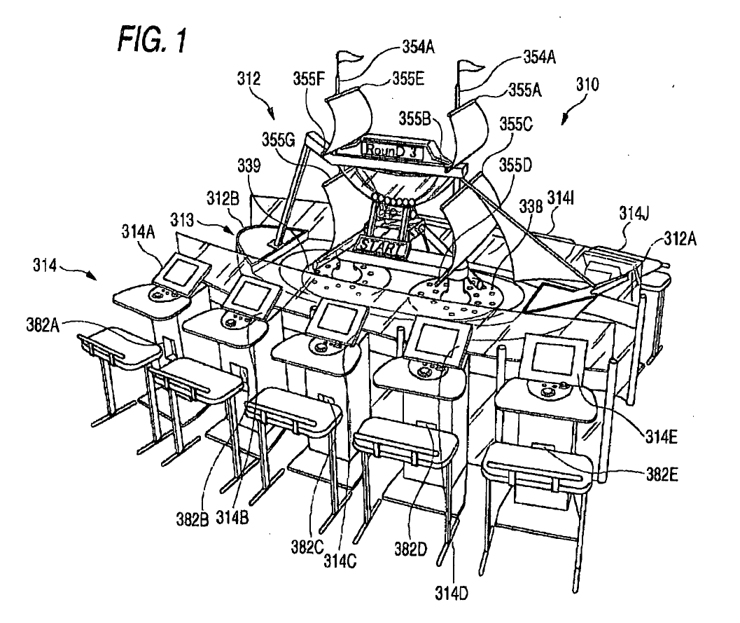

FIG. 1 is a perspective view showing a schematic appearance of a gaming machine in this embodiment.

The gaming machine 310 includes a lottery machine 312 and a plurality of gaming terminals 314. The gaming machine 310 can simultaneously provide a game to a plurality of game players through the plurality of gaming terminals 314A to 314J.

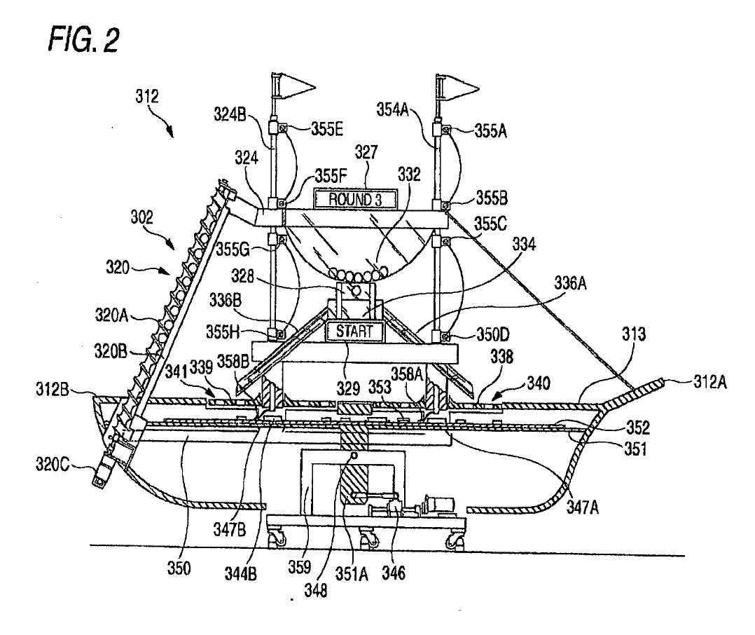

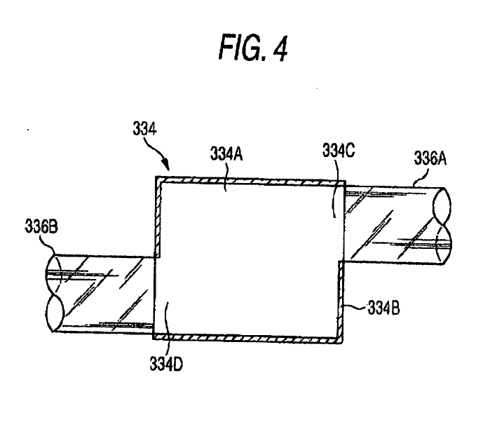

The lottery machine 312 mainly includes a cabinet 313 having a form imitating a ship and is placed at the center of the gaming machine 310. Furthermore, two lottery wheels 338 and 339 are placed at the center of the lottery machine 312. These two lottery wheels 338 and 339 have 52 lottery holes 340 and 341 in total (see FIG. 4). These plural lottery holes 340 and 341 are associated with indicias, which are combinations of first signs including spades, clubs, hearts and diamonds, and second signs including numbers from 2 to 10 and letters A, J, Q and K. The indicia is used for determining a lottery result. In other words, indicias for determining lottery results are associated with the plurality of lottery holes 340 and 341 in the lottery wheels 338 and 339, respectively A lottery is performed in accordance with one of the plurality of lottery holes 340 and 341 to which a lottery ball enters, and the game result is determined. Two struts 354A and 354B compared to masts of a ship extend upward from the respective centers of the lottery wheels 338 and 339. Metallic horizontal bars 355A to 355H are attached to the struts 354A and 354B, respectively, substantially orthogonally to each other with metallic latches so as to become parts of the masts of the ship, which are decorations of the lottery machine. An rocking device 346 (see FIG. 2) including a motor is placed in the lottery machine 312 so that the cabinet 313 can be rocked to move a stem 312A and a stern 312B vertically. In other words, the rocking device 346 rocks the cabinet 313. Notably, the incline has an angle of about 8 degree vertically with respect to the horizontal plane in this embodiment but is not limited thereto. Furthermore, while the oscillating operation takes about 12 seconds from the state that the stem 312A is positioned above at an angle of about 8 degree with respect to the horizontal plane to the state that the stem 312A is positioned below at an angle of about 8 degrees with respect to the horizontal plane, the time is not limited thereto. Preferably, the oscillating operation takes about 8 seconds to about 16 seconds. More specifically, the cycle of the rocking can be controlled by a main control circuit 400, which will be described later, and may be defined to be adjustable by, for example, a manager of the game arcade. Furthermore, since the ship-shaped cabinet 313 is used, which can be rocked, in this embodiment, a visual effect can be given to game players, which can therefore enhance the amusingness.

A plurality of gaming terminals 314A to 314J are placed on both sides of the lottery machine 312. In this embodiment, 10 gaming terminals 314 to 314J are provided. The plurality of gaming terminals 314A to 314J have medal payout ports 382A to 382J. FIG. 1 does not show the gaming terminals 314F to 314H and medal payout ports 382F to 382J, which are hidden by the lottery machine 312.

While, in this embodiment, the ten gaming terminals 314A to 314J are provided as the plurality of gaming terminals, the invention is not limited thereto, but other forms may be adopted. For example, different gaming terminals rather than ten gaming terminals may be provided or one gaming terminal may be provided.

Configuration of Lottery Machine

FIG. 2 is a longitudinal sectional view showing a schematic appearance of the lottery machine 312 in this embodiment.

The lottery machine 312 includes the cabinet 313 made of a synthetic resin and in imitation of the hull of a ship and a metallic cabinet frame 351 internally supporting the cabinet. A supporting piece 351A extends downwards from the substantial center of the cabinet frame 351, and the supporting piece 351A has a rocking axis 348. The cabinet 313 and cabinet frame 351 are oscillatably supported by a rocking frame 359 about the rocking axis 348. In this case, the rocking frame 359 is a base of the lottery machine. The rocking device 364 is provided in the rocking frame 359 of the lottery machine 312 and moves the supporting piece 351A. Thus, the cabinet 313 can be inclined about the rocking axis 348.

An attachment base 352 made of wood is fixed and mounted on the cabinet frame 351. The attachment base 352 is used for mounting a controller for controlling different devices of the lottery machine 312. A control circuit substrate 353, which will be described later as one of controllers, is mounted on the attachment base 352.

As an example of an lifting device, a screw conveyer 320 is placed in the stern 312B of the lottery machine 312. The screw conveyer 320 is an apparatus for conveying a lottery ball used for a lottery upward with respect to the lottery wheels 338 and 339 through the internal part of the lottery machine 312. While the lottery ball in this embodiment has a diameter of about 60 mm, other forms may be adopted therefor. For example, the lottery ball may have a diameter equal to, larger than or smaller than about 60 mm. Furthermore, the lottery ball is preferably made of a material not allowing infrared ray to pass through or is preferably processed so as not to allow infrared ray to pass through such that the lottery ball can be easily detected by different kinds of sensors such as an optical sensor.

The screw conveyer 320 includes a spiral body 320A, a supporting plate 320B and a lottery ball lifting motor 320C. The spiral body 320A extends upward from a conveyance start position 320D at a predetermined angle of inclination. The supporting plate 320B extends along the spiral body 320A. The lottery ball lifting motor 320C rotates the spiral body 320A. The spiral body 320A has a helical groove having a radius of curvature larger than a radius of the lottery ball. Driving the lottery ball lifting motor 320C rotates the spiral body 320A, and a lottery ball is conveyed to the upper part with the lottery ball retained between the helical groove in the spiral body 320A and the supporting plate 320B. The screw conveyer 320 conveys the lottery ball 302 to be conveyed in a manner that the lottery ball 302 can be visually checked.

One end of a lottery ball guide portion 324 is provided at the upper end of the screw conveyer 320. The lottery ball guide portion 324 has a guide path (not shown). The lottery ball guide portion 324 guides a lottery ball conveyed by the screw conveyer 320 through the guide path.

A lottery ball holding portion 332 is provided in the upper part of the lottery machine 312. The lottery ball holding portion 332 stands on the cabinet 313 and is supported by the struts 354A and 354B extending upward from the center position of the lottery wheel. The lottery ball holding portion 332 is made of a transparent resin such that game players and so on can visually check. Thus, the number of remaining lottery balls can be clearly shown to game players. The lottery ball holding portion 332 opens upward in form and holds lottery balls having been guided thereto from the lottery ball guide portion 324. The bottom of the lottery ball holding portion 332 has an opening (not shown) for allowing one lottery ball to pass through.

A rotary body 328 is provided below the lottery ball holding portion 332. The rotary body 328 is cylindrical and is an example of a dropping portion. The rotary body 328 has a function of closing the opening in the bottom surface of the lottery ball holding portion 332. Thus, the state that a lottery ball is held in the lottery ball holding portion 332 can be maintained.

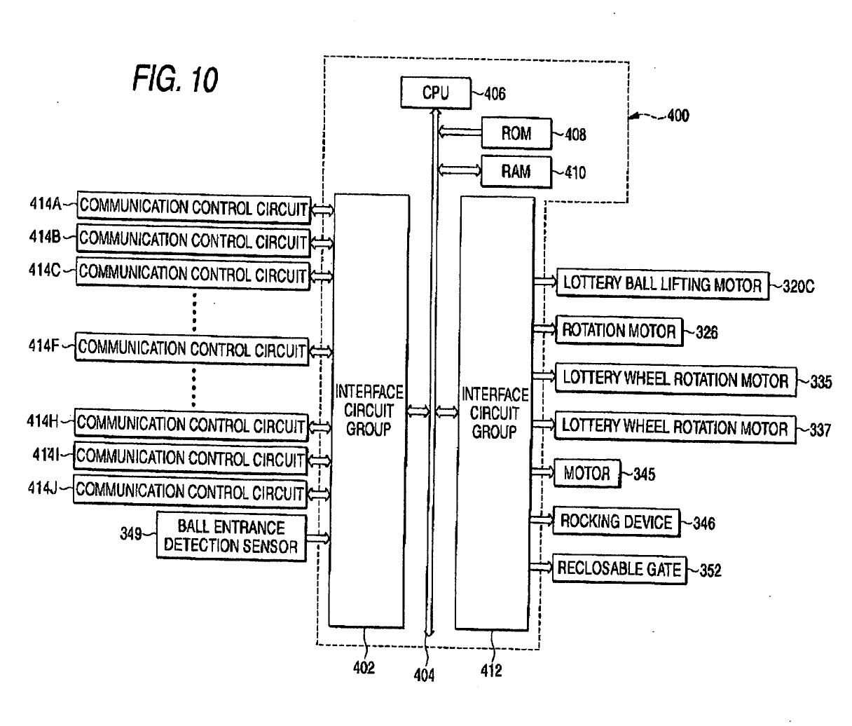

The rotary body 328 has a holding hole (not shown) for holding one lottery ball. A drive portion (not shown) including a rotation motor 326 (see FIG. 10) is provided at the edge of the rotary body 328. Driving the drive portion rotates the rotary body 328. Rotating the rotary body 328 opens the holding hole to the above so that one lottery ball held in the lottery ball holding portion 332 can be dropped to the holding hole through the opening. Furthermore, rotating the rotary body 328 closes the opening in the lottery ball holding portion 332 and holds one lottery ball in the holding hole. Furthermore, rotating the rotary body 328 closes the opening in the lottery ball holding portion 332 and opens the holding hole to the bottom so that one lottery ball held in the holding hole can be dropped downward. Thus, one lottery ball held in the lottery ball holding portion 332 can be extracted and dropped downward. In other words, the rotary body 328 has a function of dropping a lottery ball having been conveyed by the screw conveyer 320 from the upper part to plane portions 338A and 339A. The rotary body 328 is made of a transparent resin such that a lottery ball held in the holding hole can be visually checked by game players. Thus, the developments of a game can be clearly shown to game players.

A transparent lottery ball receiving portion 334 is provided below the rotary body 328. The lottery ball receiving portion 334 receives a lottery ball dropped from the holding hole of the rotary body thereabove. Thus, a lottery ball having been dropped from the holding hole of the rotary body 328 is held in the lottery ball receiving portion 334 with the lottery ball visually checkable by game players. The lottery ball receiving portion 334 has notches 334C and 334D (see FIG. 4) through which a received lottery ball can be dropped to one of the lottery wheels 338 and 339. Since the lottery machine 312 has a function of oscillating, a lottery ball held in the lottery ball receiving portion 334 is guided to one of the two lottery wheels 338 and 339 in accordance with the angle of inclination thereof.

Slopes 336A and 336B having inrut paths allowing lottery balls to pass through are provided to the notches 334C and 334D (see FIG. 4) of the lottery ball receiving portion 334. These slopes 336A and 336B are used for dropping a lottery ball held in the lottery ball receiving portion 334 to one of the lottery wheels 338 and 339. The slopes 336A and 336B are made of a transparent resin. Thus, lottery balls passing through the slopes 336A and 336B can be visually checked by game players. In this way, the above-described screw conveyer 320, rotary body 328, slopes 336A and 336B and so on can drop lottery balls having been discharged from the plurality of lottery holes 340 and 341 to the lottery wheels 338 and 339 through a collection path 350 as described later.

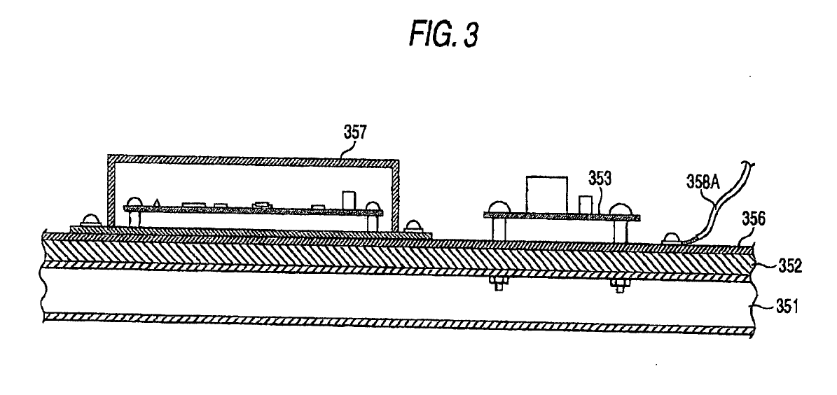

The metallic struts 354A and 354B supporting the lottery ball holding portion 332 are connected to a ground plane 356 (see FIG. 3) on the surface of the ground plane 356 of the attachment base 352 through conductors 358A and 358B, respectively.

The two lottery wheels 338 and 339 are placed at the lower ends of the slopes 336A and 336B. These lottery wheels 338 and 339 have plane portions 338A and 339A, respectively, having surfaces horizontal to the cabinet 313. Lottery balls can roll on the plane portions 338A and 339A. In other words, the lottery wheels 338 and 339 have plane portions 338A and 339A, respectively, on which lottery balls can roll and have the plurality of lottery holes 340 and 341 in the upper surface of the plane portions 338A and 339A. Furthermore, these two lottery wheels 338 and 339 can rotate horizontally with respect to the upper surfaces of the plane portions 338A and 339A.

The upper surfaces of these plane portions 338A and 339A have the plurality of lottery holes 340 and 341 each for holding one lottery ball. These plural lottery holes 340 and 341 are deep enough for one lottery ball to project about 2/5. Thus, lottery balls having entered to these plural lottery holes 340 and 341 are held in a manner that game players can visually check the lottery balls. Furthermore, subsequently dropped lottery balls come into collision with the lottery balls held in the plurality of lottery holes 340 and 341 and change the direction of rolling. As described later, the lottery balls having entered to the lottery holes 340 and 341 move in response to rotations of lottery wheels 338 and 339 with the lottery balls held in the lottery holes 340 and 341 until the end of one game.

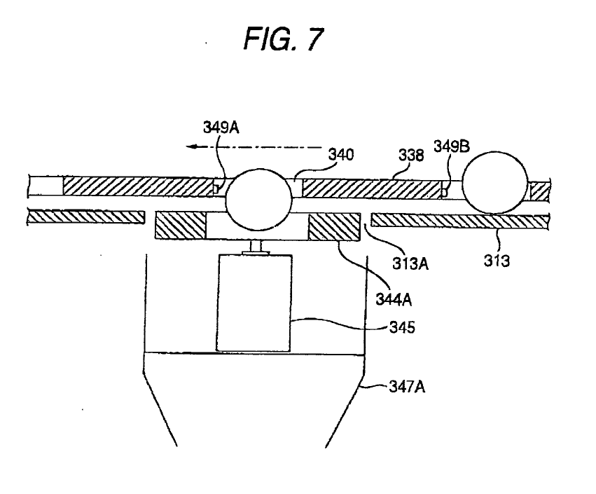

Open/close shutter s 344 (344A and 344B) (FIG. 7) are provided below the lottery wheels 338 and 339 at positions through which the lottery holes 340 and 341 pass in response to the rotation of the lottery wheels 338 and 339. While a game is being played, the open/close shutter s 344A and 344B are controlled to close, and the lottery wheels 338 and 339 hold lottery balls in the lottery holes 340 and 341. After the game ends, the open/close shutter s 344A and 344B are controlled to open, and the lottery balls in the plurality of lottery holes 340 and 341 are discharged through an discharge path 347 (FIG. 7) and collection path 350 disposed below the lottery wheels 338 and 339.

As shown in FIG. 7, ball entrance detection sensors 349 (ball entrance detection sensors 349A and 349B in FIG. 7) are provided in the lottery holes 340 and 341. Each of the ball entrance detection sensors 349 detects that a lottery ball enters to one of the plurality of lottery holes. On the condition that a lottery ball enters to one of the plurality of lottery holes 340 and 341 in the lottery wheels 338 and 339, indicia is selected in accordance with the lottery hole to which the lottery ball has entered, and a game result thereof is determined based on the selected indicia. In other words, on the condition that a lottery ball has entered to one of the plurality of lottery holes 340 and 341, the game result is determined based on the indicia associated with one of the plurality of lottery holes 340 and 341 to which the lottery ball has entered. While, in this embodiment, one ball entrance detection sensor 349 is provided in each of the plurality of lottery holes 340 and 341, other forms may be adopted. For example, a plurality of ball entrance detection sensors may be provided for each of plural lottery holes such that the fact that a lottery ball has entered thereto can be immediately detected. Furthermore, in order to reduce works in a producing process therefor and to reduce costs, an ball entrance detection sensor may not be provided in each of the plurality of lottery holes. In other words, two ball entrance detection sensors may be used to detect that lottery balls have entered to plural lottery holes. For example, a fixed sensor may be provided below a lottery wheel so that a lottery hole to which a lottery ball has entered can be located based on a rotating position of the lottery wheel when the lottery wheel rotates and the sensor detects that the lottery ball passes.

The collection path 350 is provided under the lottery wheels 338 and 339. An discharged lottery ball drops down into the collection path 350. The collection path 350 extends to the conveyance start position of the lifting device, and a lottery ball rolls within the collection path 350 by being guided toward the conveyance start position.

The lottery machine 312 rocks such that the stern 312B side can be lower than the stem 312A side. Thus, a lottery ball held in the collection path 350 is guided to the lower end of the spiral body 320A.

A dot LED display device 327 is provided above the lottery ball holding portion 332. The dot LED display device 327 includes a plurality of LEDs. The dot LED display device 327 displays a round number in a game. A START lamp 329 is provided at the center of the lottery machine 312. The START lamp 329 contains a lamp lighting up when a lottery ball drops down from the holding hole of the rotary body 328 to the lottery ball receiving portion 334. In response to the lighting-up of the contained lamp, the word, START, is displayed so that game players can visually check it. Furthemore, the gaming machine 310 includes a plurality of illumination apparatus (not shown) so that the ship-shaped lottery machine 312 can be lighted up in various colors and various effects can be given in response to rocking operations.

Cabinet Frame and Attachment Base

FIG. 3 is a partial sectional view showing the cabinet frame 351 and attachment base 352 within the cabinet 313. The cabinet frame 351 includes a plurality of metallic tubes aligned in parallel. Since each of the tubes in the cabinet frame 351 has a square section, the tubes have an upper surface being flat. The attachment base 352 made of wood is fixed on the cabinet frame 351 with bolts. A conductive film made of aluminum foil is adhered onto the substantially entire surface of the attachment base 352 and serves as the ground plane 356 on the attachment base 352. The adhesion of aluminum foil can eliminate the necessity of the attachment base 352 made of a conductive material, which can increase flexibility in material selection. In this embodiment, the attachment base 352 made of wood can be light-weight and be readily machined.

The attachment base 352 is fixed from the upper part of the ground plane 356 to the cabinet frame 351 with metallic bolts, and the cabinet frame 351 is electrically connected to the ground plane 356 made of aluminum foil. Various control substrates such as the control circuit substrate 353 are attached onto the ground plane 356 of the attachment base 352. The grounds of the substrates are connected to the ground plane 356. Furthermore, some of the substrates are covered with a shield case 357 and then are attached onto the attachment base 352. In this case, since the shield case 357 is directly in contact with the ground plane 356, both of them are electrically connected. The control circuit substrate 353 functions as a detector for detecting that a lottery ball enters to a lottery hole.

The attachment base 352 is placed widely within the cabinet 313 so that the internal part of the cabinet 313 can be horizontally divided into two (FIG. 2). Since the substantially entire surface on the attachment base 352 is the ground plane 356, a horizontally wide ground plane is provided within the cabinet, and this is grounded to the cabinet frame. Thus, radiant noise generated by the gaming machine 310 can be suppressed. Furthermore, since the internal part of the cabinet 313 is horizontally divided into two by the ground plane 356, the amount of radiant noise generated by the motor of the rocking device 346 under the ground plane 356 and reaching to the control substrates such as the control circuit substrate 353 above the rocking device 346 can be reduced.

The conductor 358A connecting to the strut 354A (FIG. 2) is connected to the ground plane 356 of the attachment base 352. The conductor 358B, not shown in FIG. 3, connecting to the strut 354B (FIG. 2) is also connected to the ground plane 356 like the conductor 358A. Thus, the struts 354A and 354B are electrically connected to the ground plane 356 of the attachment base 352. Furthermore, since the struts 354A and 354B are electrically connected to the horizontal bars 355A to 355D and 355E to 355H, respectively, the struts 354A and 354B and horizontal bars 355A to 355H are all grounded. A motor for controlling movement of a lottery ball in the lottery ball holding portion 332 is adjacent to illumination lamps in the vicinity of the struts 354A and 354B. Thus, radiant noise generated by a change in current fed thereto may be diffused by using the metallic struts 354A and 354B and horizontal bars 355A to 355H as antennas. However, the diffusion of radiant noise can be suppressed by grounding the struts 354A and 354B and horizontal bars 355A to 355H. Thus, the radiant noise generated by the gaming machine can be suppressed by grounding the struts 354A and 354B. The struts 354A and 354B rock in response to the rocking of the cabinet 313 along with the lottery wheels 338 and 339 so that the rocking of the cabinet 313 can be visually emphasized. Therefore, the generated radiant noise can be suppressed, and presence can be enhanced by the rocking of the cabinet, which can increase amusingness of the game.

The ground plane 356 of the attachment base 352 is electrically connected to the rocking frame 359 through the cabinet frame 351, supporting piece 351A and rocking axis 348. Furthermore, the rocking frame 359 is electrically connected to the motor cabinet of the rocking device 346. Since all of them are therefore grounded, the generation of radiant noise can be suppressed.

Besides, contents of a test of a radiated noise are shown below.

An allowable value with noise power is equal to or less than 55 dB in 30 MHz-300 MHz.

An allowable value with noise voltage among the terminals is equal to or less than 56 dB in 526.5 kHz-30 MHz, and equal to or less than 60 dB in 5 MHz-30 MHz.

Lottery Ball Receiving Portion

FIG. 4 is a top view showing the lottery receiving portion 334 and slopes 336A and 336B. The lottery ball receiving portion 334 has a recessed portion 334A The recessed portion 334A receives lottery balls dropping from the holding holes of the rotary body 328. A side 334B of the lottery ball receiving portion 334 has two notches 334C and 334D. Thus, the lottery ball received by the recessed portion 334A rolls from one of the two notches 334C and 334D to the outside of the recessed portion 334A in response to the rocking of the lottery machine 312.

The upper ends of the slopes 336A and 336B are connected to these notches 334C and 334D. Furthermore, the lower ends of the slopes 336A and 336B are placed above the lottery wheels 338 and 339, respectively, as described above. Thus, these slopes 336A and 336B receive lottery balls rolled from the notches 334C and 334D of the above-described lottery ball receiving portion 334 to the outside of the lottery ball receiving portion 334 and are then guided to one of the lottery wheels 338 and 339. Each of these slopes 336A and 336B is placed such that lottery balls can be dropped in the same direction as the direction of rotation of each of the lottery wheels 338 and 339. While, in this embodiment, the slope 336A and 336 have a straight form, they do not have to have a straight form but may have a curve, for example.

Lottery Wheels

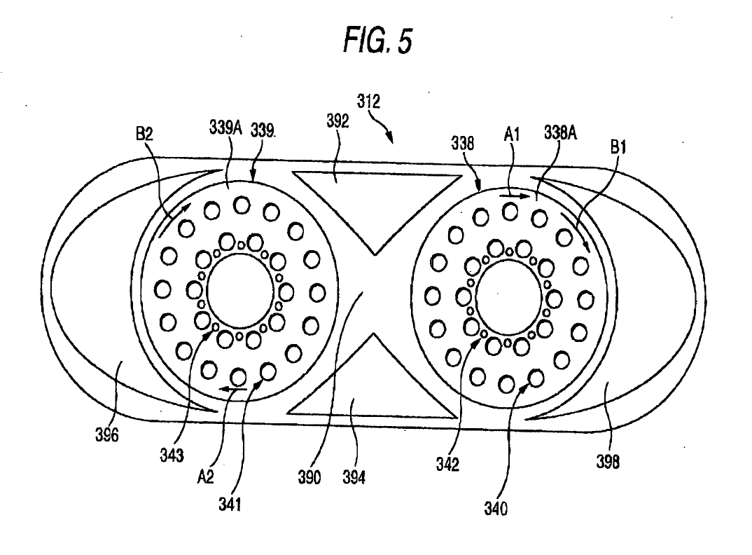

FIG. 5 is a top view showing the lottery machine 312 and lottery wheels 338 and 339. Since the lottery wheel 339 has a similar configuration to that of the lottery wheel 338, the description will be omitted herein. As shown in FIG. 5, the lottery machine 312 includes the two lottery wheels 338 and 339 as described above. Since the two lottery wheels 338 and 339 can have the plurality of lottery holes 340 and 341, the installed space in a place of amusingness can be used more effectively without requiring a wasteful space required for many lottery holes than the space having one lottery wheel, for example. Thus, the lottery wheels can have many lottery holes, which can increase amusingness such as providing a variety of dividends.

The lottery wheels 338 and 339 are circular in the top view. These lottery wheels 338 and 339 are rotatably provided at positions on the deck of the cabinet 313 having a form in imitation of a ship. The standard rotational speed of the lottery wheel 338 is a speed at which one rotation takes 8 to 12 seconds but can be controlled by a main control circuit 400, which will be described later. For example, the rotational speed can be adjusted in the range of 5 to 12 seconds per rotation. While, in this embodiment, the lottery wheels 338 and 339 are pivoted by lottery wheel rotation motors 335 and 337 (see FIG. 10) positioned at the respective center thereof, other forms can be adopted. For example, power for rotation can be conducted from other parts such as outer peripheries and bottom surfaces thereof. The lottery wheels 338 and 339 have the plane portions 338A and 339A, which allows rolling of lottery balls. Furthermore, the lottery wheels 338 and 339 rotate in the same directions (see arrows B1 and B2) as the directions (see arrows A1 and A2) in which lottery balls are dropped from the slopes 336A and 336B. More specifically, the lottery wheel 338 rotates clockwise, and the slope 336A is disposed in the clockwise direction as shown in FIG. 5. Thus, when lottery balls roll on the lottery wheels 338 and 339, the speed does not rapidly decrease. Therefore, the possibility is low that a lottery ball enters to one of the plurality of lottery holes 340 and 341 in an extremely short period of time. Furthermore, the rotation of the lottery wheels 338 and 339 allows lotteries to be performed without any change in speed of lottery balls sequentially dropped from the slopes 336A and 336B. When the lottery wheels 338 and 339 do not rotate, that is, the positions of the lottery holes 340 and 341 are not changed, an uneven game can be achieved in which a lottery ball dropped at a predetermined speed can easily or hardly enter a specific one of the plurality of lottery holes 340 and 341. The rotation of the lottery wheels 338 and 339 can prevent uneven lotteries.

A connection table 390 is provided between the two lottery wheels 338 and 339. The connection table 390 has a surface horizontal to the plane portions 338A and 339A of the lottery wheels 338 and 339. Thus, a lottery ball can roll between the lottery wheels 338 and 339. Furthermore, in response to the inclining (rocking) of the cabinet 313, a lottery ball rolls across the plurality of lottery wheels 338 and 339.

Guide portions 392 and 394 are provided between the lottery wheels 338 and 339. These guide portions 392 and 394 are provided at positions sandwiching the connection table 390 along the outer peripheries of the lottery wheels 338 and 339. These guide portions 392 and 394 are higher than the plane portions 338A and 339A of the lottery wheels 338 and 339 and have a convex fore. Lottery balls come into collision with the guide portion 392 and 394 so that the orbits of the lottery balls can be guided.

Bank portions 396 and 398 are provided outside the lottery wheels 338 and 339. These bank portions 396 and 398 are provided along the outer peripheries of the lottery wheels 338 and 339. These bank portions 396 and 398 are higher than the plane portions 338A and 339A of the lottery wheels 338 and 339 and have a convex form. In other words, the bank portions 396 and 398 higher than the top surface of the plane portions 338A and 339A are provided along the outer peripheries of these plane portions 338A and 339A. Thus, even when lottery balls dropped from the slopes 336A and 336B to the lottery wheels 338 and 339 roll to the outside of the lottery wheels 338 and 339, the lottery balls ran onto the bank portions 396 and 398 and roll on the lottery wheels 338 and 339 again. Furthermore, since the orbits of lottery balls returning from the bank portions 396 and 398 are changed by momentum and/or directions of the lottery balls running onto the bank portions 396 and 398, an unpredictable game can be provided to game players, which can enhance amusingness of the game. Furthermore, when lottery balls having run onto the bank portions 396 and 398 roll on the lottery wheels 338 and 339, the speed does not significantly decrease. Thus, when the lottery balls having run onto the bank portions 396 and 398 roll onto the lottery wheels 338 and 339, the speed does not significantly decrease. Therefore, the possibility is low that a lottery ball enters to one of the plurality of lottery holes 340 and 341 in an extremely short period of time, and a lottery ball enters to one of the plurality of lottery holes 340 and 341 in about 10 to 30 seconds.

Furthermore, the lottery wheels 338 and 339 rotate in the opposite directions as indicated by the arrows B1 and B2. Thus, lottery balls having dropped to the lottery wheel 338 roll from the lottery wheel 338 to the lottery wheel 339 through the connection table 390. Conversely, lottery balls having dropped to the lottery wheel 339 rolls from the lottery wheel 339 to the lottery wheel 338 through the connection table 390. Thus, lottery balls roll between the lottery wheels 338 and 339. Furthermore, since the rocking device 346 is provided in the lottery machine 312, the cabinet 313 of the lottery machine 312 is rocked thereby. Then, for example, lottery balls are rolled in infinity orbit between the lottery wheels 338 and 339. Thus, an unpredictable and innovative game can be provided to game players, which can enhance amusingness of the game. Notably, the lottery wheels 338 and 339, connection table 390, guide portions 392 and 394 and bank portions 396 and 398 are enclosed by a fence made of a transparent resin so that no lottery balls can roll to the outside of the fence.

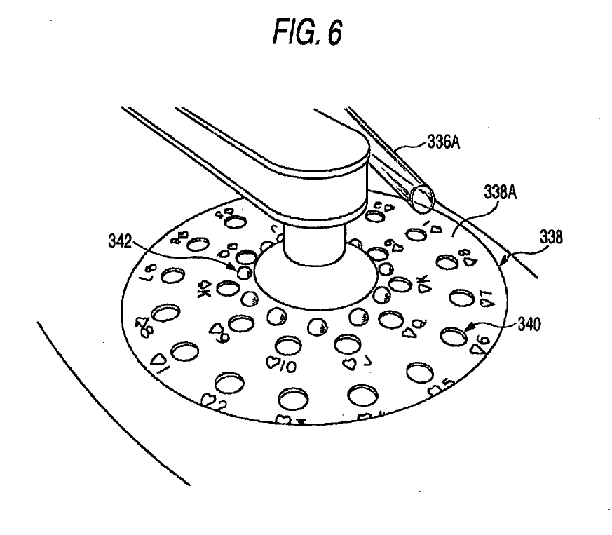

These lottery wheels 338 and 339 have 26 lottery holes 340 and 26 lottery holes 341, respectively. As shown in FIG. 6, indicias including spades and hearts as first signs are assigned to the plurality of lottery holes 340 in the lottery wheel 338. More specifically, A, 2 to 10, J, Q and K of spades and A, 2 to 10, J, Q and K of hearts are assigned to the plurality of lottery holes 340 in the lottery wheel 338. On the other hand, indicias including clubs and diamonds as first signs are assigned to the plurality of lottery holes 341 in the lottery wheel 339. More specifically, A, 2 to 10, J, Q and X of clubs and A, 2 to 10, J, Q and K of diamonds are assigned to the plurality of lottery holes 341 in the lottery wheel 339. In other words, a position where a lottery ball is rolling is visually checked for matching some of the plurality of signs so that the indicia desired by a game player can be easily recognized. Thus, haste and expectations of the game player can be more raised and amusingness of the game can be enhanced. For example, while a lottery ball is rolling on the lottery ball 338, the fact that the first sign is spades or hearts can be easily recognized. While a lottery ball is rolling on the lottery ball 339, the fact that the first sign is clubs or diamonds can be easily recognized. In other words, on the two lottery wheels 338 and 339, indicias some of first signs of which match are assigned to the plurality of lottery holes 340 and 341 in the two lottery wheels 338 and 339. Thus, a position where a lottery ball is rolling is visually checked for matching some of the plurality of signs so that the indicia desired by a game player can be easily recognized. Therefore, haste and expectations can be more raised and amusingness of the game can be enhanced.

Open/Close Shutter and Collection Path

FIG. 7 is a sectional view showing a configuration in which the open/close shutter 344A, which is a disk having two notches, is provided by being joined to the axis of rotation of the motor 345. In order to show a movement of a lottery ball, the sectional view shows a section along the outer circumference having lottery holes of the lottery wheels 338.

While the lottery wheel 338 is provided above the cabinet 313, a part of the cabinet 313 under the lottery wheel 338 has a circular hole 313A, and the open/close shutter 344A is provided in the hole. When a draw is being made, the open/close shutter 344A is closed. A lottery ball having dropped to a lottery hole is supported by the cabinet 313 and open/close shutter 344A so as to be retained not to fall any further. Once the game ends and the open/close shutter 344A is rotationally driven by 90 degrees by the motor 345, the two notches of the open/close shutter 344A are positioned under the outer circumference and inner circumference having lottery holes (the state shown in FIG. 7). When the lottery wheel 338 rotates under this state, a lottery ball having passed above the open/close shutter 344A further passes through the notches of the open/close shutter 344A and falls to the discharge path 347A. Thus, the lottery balls retained in the plurality of lottery holes 340 of the lottery wheel 338 are all discharged from the discharge path 347A as a result of one rotation of the lottery wheel 338. Then, the lottery balls enter the collection path 350 below the discharge path 347A. When all of the lottery balls have been discharged, the open/close shutter 344A is rotationally driven by 90 degrees again by the motor 345 and is closed. Since an discharging mechanism does not have to be provided to each of all of the lottery holes 340 but one centralized discharging mechanism can be provided because of this configuration, the mechanism can be simplified and the costs for producing the gaming machine can be reduced. The number of lottery balls (number of balls) discharged from the discharge path 347A in each unit time depends on the speed of rotation of the lottery wheel 338. As the speed of rotation of the lottery wheel 338 increased, the number of lottery balls to be discharged in each unit time increases.

Gaming Terminal

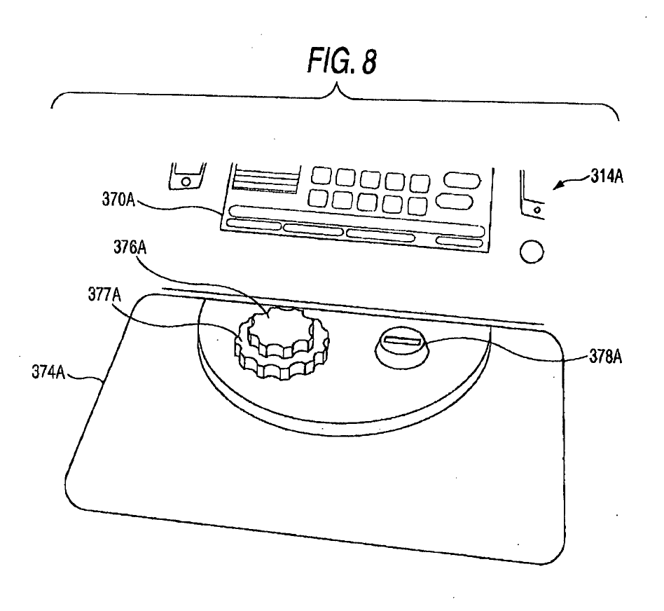

The gaming terminal 314A in the gaming machine 310 will be described with reference to FIG. 8. FIG. 8 is a perspective view showing an operation part of the gaming terminal 314 viewed from a player's position. Since the gaming terminals 314B to 314J have a configuration similar thereto, the description will be omitted herein.

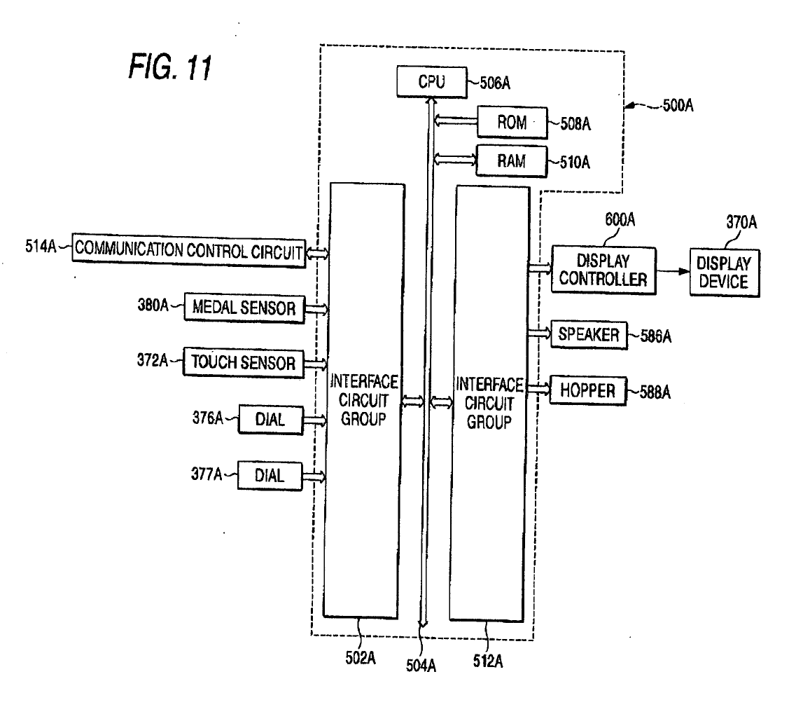

The gaming terminal 314A mainly includes a display device 370A, a touch sensor 372A (FIG. 11), two dials 376A and 377A, a medal input port 378A and a main control circuit 500A (FIG. 11).

The display device 370A is provided in the upper part of the gaming terminal 341A. A matrix card image for a bingo game assigned to a game player and other information or images relating to an optional game and so on are displayed on the display device 370A. In other words, the display device 370 includes a plurality of boxes in a plurality of rows by a plurality of columns and displays a matrix in which indicias are assigned to the respective a plurality of boxes. Furthermore, as described later, on the condition that indicia selected by the main control circuit 400 or the like agrees with one of identification pieces assigned to the respective plural boxes, the main control circuit 500A or the like controls to activate the box corresponding to one of the identification pieces and controls to give a dividend on the condition that a result from the control for activating has a predetermined form. Under this configuration, the game is developed with various kinds of information displayed on the display device 370A being visually checkable by a game player.

Furthermore, a camera (not shown) for shooting entire images of the lottery wheels 338 and 339 may be provided in the lottery machine 312. Then, by displaying a shot image on the display device 370A, the lottery wheels 338 and 339 can be visually checked by a game player even when one of the lottery wheels 338 and 339 is hard to see.

Furthermore, a touch panel mainly including the touch sensor 372A is provided in the display device 370A. Thus, at the touch of the display device 370A, a game environment allowing inputting various data or commanding can be provided to a game player.

While, in this embodiment, various input operations are allowed by the touch sensor 372A, other operation forms may be adopted. For example, a plurality of operation buttons may be provided therein so that various input operation can be performed.

A seat portion 374A is provided on the game player side of the display device 370A. The two dials 376A and 377A positioning as upper and lower layers are provided on the top surface of the seat portion 374A. By using the dials 376A and 377A, a game environment, which is hard to operate only by pressing a normal operation button or touching the touch panel, can be provided to a game player.

For example, in this embodiment, on a bingo game matrix image displayed on the display device 370A, an indicia assigned to a bingo box in the outer periphery of the matrix image can be moved to an adjacent bingo box along the outer periphery. In the past, when a second indicia needs to be moved continuously and when only pressing a normal operation button and touching the touch panel are allowed as operations, the operations must be performed again and again, which is significantly burdensome. Accordingly, by using input devices such as the dials 376A and 377A, continuous operations can be performed through one action. Thus, a highly operable game can be provided to a game player. Furthermore, operations can be performed very easily for analog movements such as scrolling on screens and moving a pointer thereon. Thus, a highly operable game can be provided to a game player.

The medal input port 378A for inserting a medal is provided on the right side of the dials 376A and 377A. A medal sensor 380A (see FIG. 11) is provided within the metal slot 378A. The medal sensor 380A senses that a medal has been inserted to the medal input port 378A. Thus, when a medal is inserted to the medal input port 378A by a game player, the fact that the medal has been inserted is sensed by the medal sensor 380A.

The main control circuit 500A is placed within the seat portion 374A and controls the above-described different devices.

System Configuration of Gaming Machine

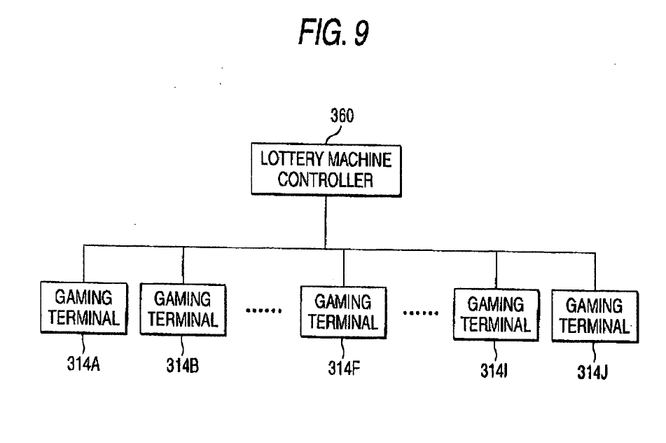

A system configuration in the gaming machine 310 will be described with reference to FIG. 9.

As shown in FIG. 9, the gaming machine 310 mainly includes a lottery machine controller 360 for controlling the lottery machine 312 and the gaming terminals 314A to 314J.

The lottery machine controller 360 is communicably connected to the ten gaming terminals 314A to 314J. The lottery machine controller 360 can control the ten gaming terminals 314A to 314J by exchanging various kinds of data and signals with the 314A to 314J.

Electric Configuration of Lottery Machine

An electric configuration in the lottery machine 312 of the gaming machine 310 will be described with reference to FIG. 10.

As shown in FIG. 10, the ball entrance detection sensor 349 is connected to an interface circuit group 402 of a main control circuit 400. When a lottery ball enters to one of the plurality of lottery holes 340 and 341 by the ball entrance detection sensor 349, a predetermined signal is supplied to an input/output bus 404 through the interface circuit group 402. The input/output bus 404 inputs/outputs data signals or address signals to a central processing unit (called CPU, hereinafter) 406. The main control circuit 400 is placed on the control circuit substrate 353. Thus, the main control circuit 400 placed on the control circuit substrate 353 functions as a detector for detecting the lottery hole 340 or 341 to which a lottery ball has entered based on a detect signal from a lottery ball passage detecting sensor 351.

Furthermore, communication control circuits 414A to 414J are connected to the interface circuit group 402. The communication control circuits 414A to 414J are used for communicably connecting the lottery machine controller 360 and the gaming terminals 314A to 314J.

A read-only memory (ROM) 408 and a random access memory (RAM) 410 are also connected to the above-described input/output bus 404. The ROM 408 records a control program for controlling processing relating to a game in the lottery machine controller 360. Furthermore, the ROM 408 stores initial data used for executing the control program and various programs. Furthermore, the RAM 410 stores values of flags and/or variants to be used in the above-described programs.

Furthermore, an interface circuit group 412 is connected to the input/output bus 404. A lottery ball lifting motor 320C, a rotation motor 326, lottery wheel rotation motors 335 and 337, a motor 345 for the open/close shutter 344, the rocking device 346 and a reclosable gate 352 are connected to the interface circuit group 412. Thus, the devices are controlled by the CPU 406 so that the above-described lottery machine 312 can be driven.

Electric Configuration of Gaming Terminal

An electric configuration of the gaming terminal 314A of the gaming machine 310 will be described with reference to FIG. 11. Since the gaming terminals 314B to 314J have configurations similar thereto, the description will be omitted herein. Each of these gaming terminals functions as an apparatus for determining details of a game along with the main control circuit 400 of the lottery machine 312.

As shown in FIG. 11, the medal sensor 380A is connected to an interface circuit group 502A of a main control circuit 500A. When a medal is inserted through the medal input port 378A by the medal sensor 380A, a predetermined signal is supplied to an input/output bus 504A through the interface circuit group 502A. The input/output bus 504A inputs/outputs data signals or address signals to a central processing unit (CPU) 506A.

Furthermore, the touch sensor 372A is also connected to the interface circuit group 502A of the main control circuit 500A. When the fact that a position displaying a command displayed on the display device 370A is touched by a game player is detected, the touch sensor 372A supplies a signal corresponding to the command to the interface circuit group 502A.

Furthermore, the dials 376A and 377A are connected to the above-described interface circuit group 502A. When the dial 376A or 377A is rotated by a game player, a signal corresponding to the angle of rotation is supplied to the interface circuit group 502A.

Furthermore, a communication control circuit 514A is connected to the interface circuit group 502A The communication control circuit 514A is communicably connected to the lottery machine controller 360 and the gaming terminal 314A.

A read-only memory (ROM) 508A and a random access memory (RAM) 510A are connected to the above-described input/output bus 504A. The ROM 508A records a control program for controlling processing relating to a game in the gaming terminal 314A. Furthermore, the ROM 508A stores initial data used for executing the control program and programs for display control in the display device 370A. Furthermore, the RAM 510A stores values of flags and/or variants to be used in the above-described programs.

Furthermore, an interface circuit group 512A is connected to the input/output bus 504A. A speaker 586A and a hopper 588A are connected to the interface circuit group 512A, and the interface circuit group 512A supplies drive signals and drive power so as to control the above-described devices in accordance with results of computing processing in the CPU 506A.

Furthermore, a display controller 600A is connected to the interface circuit group 512A. The display controller 600A supplies image signals for displaying images to the display device 370A based on an image display command supplied from the main control circuit 500A.

Standby Screen of Gaming Terminal

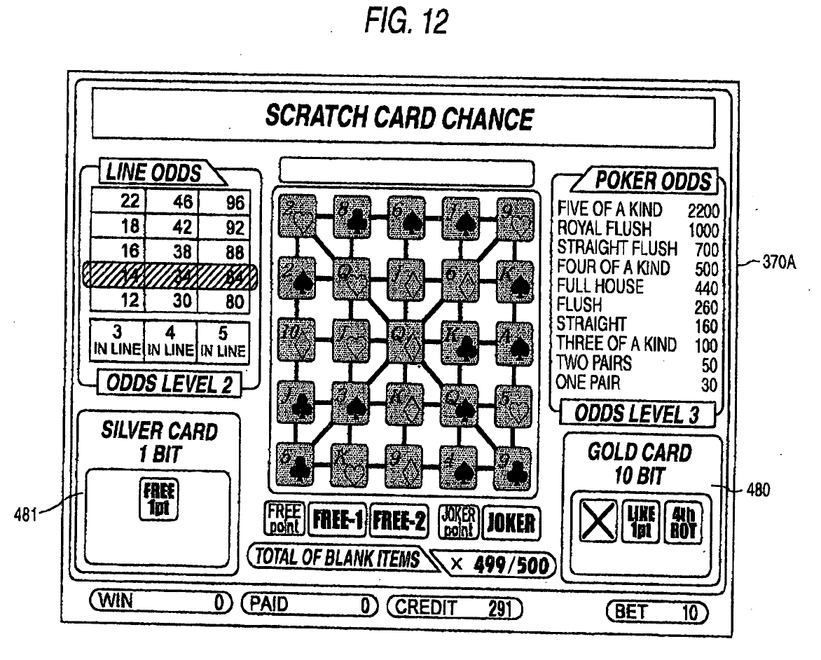

A standby screen to be displayed on the display device 370A of the gaming terminal 314A will be described with reference to FIG. 12.

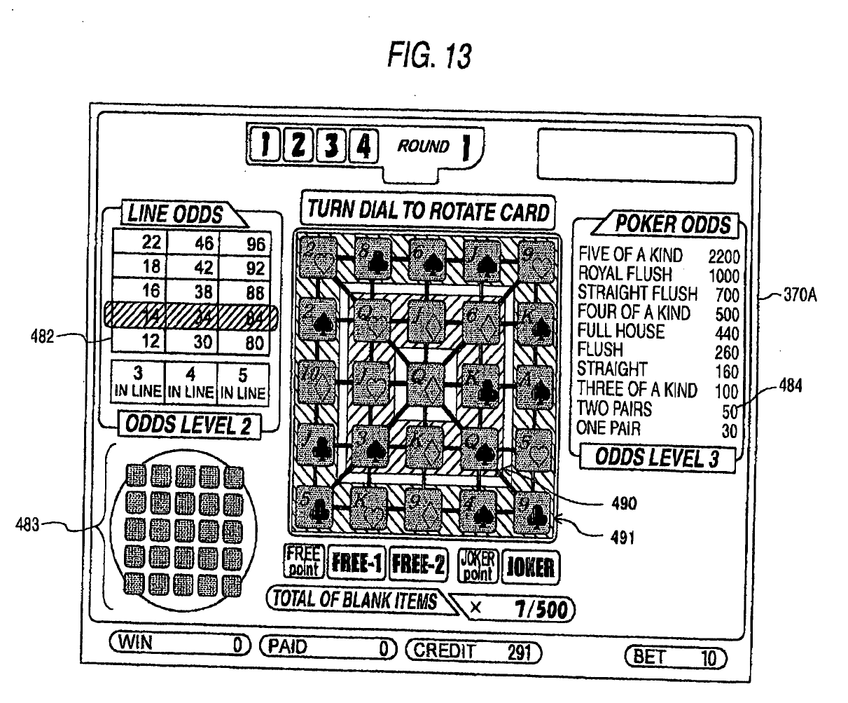

FIGS. 12 and 13 show an embodiment in which the invention is applied to a bingo game using a bingo card having 5.5 bingo boxes as described below. The conventional dominating bingo game includes drawing a predetermined number of numbers from 25 numbers at a probability of 1/25 for a bingo card having 5.5 bingo boxes, when a drawn number is on the bingo card, activating the bingo box corresponding to the number, and making a bingo hand by five activated bingo boxes in a horizontal, vertical or diagonal line. In this embodiment, instead of numbers acting as indicias used in a conventional bingo game, playing-card designs are used as indicias (where one joker or two jokers may be included or no joker may be included,.or a free spot having a specific bingo box activated irrespective of a drawn indicia may be regarded as a joker). Then, a lottery is performed at a probability of 1/52 (or at a probability of 1/53 or 1/54). In this case, in addition to conventional bingo hands, poker hands may be made (such as One Pair, Two Pair, Three Of A Kind, Straight, Flush, Full House, Four Of A Kind, Straight Flush, Royal Flush and Five Of A Kind), and a dividend in accordance with a bingo hand or poker hand is given to a game player. Furthermore, a poker hand and a bingo hand may be made in a specific same line on a bingo card at the same time, In this case, both of the dividend corresponding to the poker hand and the dividend corresponding to the bingo hand are given to a game player. However, bingo boxes are activated at a lower probability than that of a conventional bingo came, which lowers the possibility that a bingo hand is made. Accordingly, while a bingo hand is conventionally made by five activated bingo boxes in a horizontal, vertical or diagonal line, a bingo hand may be made by not only five but also three or four activated bingo boxes in a line.

Furthermore, receiving operations on the gaming terminal 314 in relation to a game is all by a touch panel method excluding operations through the dials 376A and 377A (See FIG. 8 for both of them). In other words, the touch sensor 372A (see FIG. 11) is provided on the surface of the display device 370A such that a game player can operate a gaming terminal that the game player intends by touching a predetermined touch portion of the display device 370A. However, the invention is not limited thereto, but an operation receiving method not using a touch panel method may be adopted. For example, predetermined switches may be provided for receiving operations of a game player.

FIG. 12 is an example in which a screen for receiving an entry of a game through the gaming terminal 314 is displayed on the display device 370A of the gaming terminal 314 and operations on a touch portion 480, a touch portion 481 and the dials 376A and 377A (see FIG. 8) for receiving an entry operation of a game are valid. other operations on the dial 376A and/or dial 377A (see FIG. 8 for both of them) are invalid. Furthermore, medal insertion to the medal input port 378A (see FIG. 8) is also invalid, and an inserted medal is returned to a game player from a medal payout port 382A. Furthermore, all of bingo boxes having playing-card designs in a matrix form on a bingo card displayed on the display device 370A are also displayed darker or shaded so as to indicate that the bingo boxes do not still win in a lottery and are not activated. Activating a bingo box refers to processing for displaying a bingo box having the same pattern as a playing-card design drawn by the lottery machine 312, if any, distinctively from the other bingo boxes hereinafter. Through the processing of activating a bingo box, the bingo box is displayed brighter or is unshaded, for example. Notably, a bingo box on a bingo card on the standby screen of the gaming terminal 314 is not activated based on a drawing of an indicia in the lottery machine 312. Furthermore, the values of line odds and poker odds shown on the display device 370A are not changed by any operations by a game player.

An arrangement of playing-card designs displayed on bingo cards having 5.5 bingo boxes displayed on the standby screen of the gaming terminal 314 is different from the arrangement on a bingo card to be used in a game after the game entry. Here, it is a display of a demonstration screen only, and an arrangement of playing-card designs displayed on a bingo card is not determined until the game entry.

An entry to a game is received when the touch portion 480 or touch portion 481 is touched by a game player. When the game entry is received by the gaming terminal 314, the display is changed to the screen in FIG. 13.

Screen on Gaming Terminal After Game Entry

A screen after game entry to be displayed on the display device 370A of the gaming terminal 314 will be described with reference to FIG. 13.

FIG. 13 shows a screen displaying a determined bingo card including 5.5 bingo boxes having playing-card designs. Here, playing-card designs are placed in an arrangement including a predetermined poker hand (such as a poker hand made by five playing cards, that is, Straight, Flush, Full House, Straight Flush or Royal Flush) on a specific line in advance. By preparing a high dividend hand on a bingo card in advance in this way, the expectations of a game player can be advantageously enhanced. Notably, playing-card designs are arranged at random in bingo boxes excluding the predetermined poker hand. The display of the touch portion 480 and touch portion 481 are eliminated, and the display of an entire condition notification unit 483, which will be described later, appears. At the state on the screen, a BET operation based on medal insertion by a game player or an operation on the dial 378A or 377A (see FIG. 8 for both of them) are valid for a certain period of time (such as a predetermined time like 45 seconds). For example, through a BET operation based on medal insertion by a game player, a predetermined number of medals are BET so that the level of line odds shown on a line odds table 482 can rise. Thus, the shaded part in the figure is moved upward in the figure, and the value indicating the odds level of the line odds in the figure rises (in FIG. 13, the shaded part positioned in the second row from the bottom of the line odds table 482, and the odds level is 2). Furthermore, a predetermined number of medals are BET so that the value of the poker odds shown on a poker odds table 484 can increase and the value on the display of the odds level of the poker odds in the figure can increase in the same manner (in the figure, the odds values for poker hands are as displayed, and the odds level of the poker odds is 3). Odds level here refers to an index indicating the rank among hierarchies of odds values. In this case, odds values are divided into a predetermined number of hierarchies in accordance with the magnitudes of odds values. For example, the odds value may increase as the value of the odds level increases, or the odds value may decrease as the value of odds level decreases.

Also on the display device 370A of the gaming terminal after a game entry, bingo boxes on a bingo card may be all displayed darker or shaded so that the bingo boxes are indicated as bingo boxes, which are not won in the lottery and are not activated.

When a BET operation based on medal insertion by a game player and an operation on the dial 376A and/or dial 377A (see FIG. 8 for both of them) are valid, a game player can rotationally move a bingo box in the inner periphery 490 of the bingo card Hatched with lines oriented diagonally upward right as seen in FIG. 13 by operating the dial 376A and can rotationally move a bingo box in the outer periphery 491 of a bingo card Hatched with lines oriented diagonally downward right as seen in FIG. 13 by operating the dial 377A. More specifically, when a game player rotationally operates the dial 376A counterclockwise by a predetermined amount, the bingo box in the inner radius 490 of the bingo cards is, in accordance thereto, also rotationally moved counterclockwise about the center of the bingo cards only by the predetermined amount. For example, when the dial 376A is rotationally operated counterclockwise by an amount corresponding to the amount of movement equal to one bingo box, Queen of hearts positioning at the upper left corner of the inner radius 490 of the bingo cards in FIG. 13 moves to a place having Jack of hearts, and Jack of hearts moves to a place having 3 of clubs. In this way, each of bingo boxes moves counterclockwise by one. This is also true for the rotational movement in the outer periphery 491 of the bingo card in response to an operation on the dial 377A. Thus, a game player can move a bingo box rotationally in an arbitrary manner about the center of the bingo card. Then, the operation is an operation allowed as far as the operations can be received in the gaming terminal 314. By allowing this kind of operation, bingo boxes must be moved not only to have an arrangement highly possibly making a bingo hand but also in consideration of a poker hand, which requires a strategy. Requiring a strategy means that bingo boxes rust be moved in consideration of whether Two Pair having a high possibility to be made while giving a low dividend is aimed or Royal Flush having a low possibility to be made while giving a high dividend is aimed.

As the above, according to the invention, substantially all of one surface of the attachment base fixed to the cabinet frame within the cabinet is a ground plane, and the cabinet frame and strut are electrically connected thereto. The attachment base to which the detector is attached and the strut extending upward are grounded so that the radiant noise generated by the gaming machine can be suppressed. Furthermore, the strut and the lottery wheel rock in response to the rocking of the cabinet so that the rocking of the cabinet can be visually emphasized. Therefore, the generated radiant noise can be suppressed, and the presence can be enhanced by the rocking of the cabinet, which can increase the amusingness of a game.

According to the invention, since a conductive film can be adhered to the surface of the ground plane of the attachment base, a nonconductive material can be adopted as a material of the attachment base. Therefore, a wood or synthetic resin, which can be readily machined, may be used to produce the attachment base.

According to the invention, the strut and horizontal bars standing above the lottery wheel can be decorated as a mast of a ship, and the plurality of conductive horizontal bars are grounded as well as the strut, which can suppress radiant noise.

According to the invention, substantially all of one surface of the attachment fixed to the cabinet frame within the cabinet is a ground plane, and the cabinet frame and strut are electrically connected thereto. The attachment base to which the detector is attached and the strut extending upward are grounded so that radiant noise generated by the gaming machine can be suppressed.

Though the embodiments of the invention were described, specific examples thereof were only illustrated, and the invention is not especially limited thereby.

In the description of the embodiments, the cabinet 313 is made of a synthetic resin but is not limited thereto. For example, the cabinet 313 may be made of wood.

The attachment base 352 was described as a wood plate but is not limited thereto. For example, as the attachment base 352, a plate made of metal instead of a nonconductive material such as a synthetic resin may be adopted.

The ground plane 356 on the attachment base 352 was described as a conductive film containing aluminum foil adhered thereon but is not limited thereto. For example, a conductive substance may be painted thereon.

The advantages described in the embodiments of the invention are a list of the most preferably advantages achieved by the invention, and advantages of the invention are not limited to those described in the embodiments of the invention.

1. A gaming machine comprising:
a cabinet frame;
a non-conductive cabinet having the cabinet frame therein;
a rocking frame oscillatably supporting the non-conductive cabinet;
an rocking device for rocking the non-conductive cabinet;
an attachment base attached to the cabinet frame, at least one substantially entire surface of which is a ground plane;
a lottery wheel disposed above the attachment base and having a plurality of lottery holes which accept lottery balls;
a discharge device that is provided below the lottery wheel and that discharges the lottery balls accepted in, the plural lottery holes;
a control substrate electrically connected to the ground plane for detecting that a lottery ball accepted in the lottery hole.

2. The gaming machine according to claim 1, further comprising
a strut extending upward from a face of the lottery wheel and electrically connecting to the cabinet frame and the ground plane.

3. The gaming machine according to claim 1,
wherein the ground plane comprises a conductive film provided on a surface of the attachment board.

4. The gaming machine according to claim 2,
wherein the strut includes a plurality of horizontal bars substantially orthogonal to the strut, and the horizontal bars are grounded to the strut.

5. A gaming machine comprising:
a cabinet frame;
a cabinet having the cabinet frame therein;
a rocking frame oscillatably supporting the non-conductive cabinet;
an rocking device for rocking the non-conductive cabinet;
an attachment base attached to the cabinet frame, at least one substantially entire surface of which is a ground plane;
a lottery wheel disposed above the attachment base and having a plurality of lottery holes which accept lottery balls;
a detector attached to the attachment base for detecting that a lottery ball accepted in the lottery hole; and
a strut extending upward from a face of the lottery wheel and electrically connecting to the cabinet frame and the ground plane.

6. The gaming machine according to claim 5,
wherein the ground plane comprises a conductive film provided on a surface of the attachment boards

7. The gaming machine according to claim 5,
wherein the strut includes a plurality of horizontal bars substantially orthogonal to the strut, and the horizontal bars are grounded to the strut.
